(19) United States
(12) Patent Application Publication
(10) Pub. No.: US 2018/0138694 A1
(43) Pub. Date: May 17, 2018

(54) SHORT DETECTION AND PREVENTION FOR INVERTER SENSOR INPUTS

(71) Applicant: Ford Global Technologies, LLC, Dearborn, MI (US)

(72) Inventors: Jaswant Singh Garcha, Windsor (CA); Lihua Chen, Farmington Hills, MI (US); Shahram Zarei, Farmington Hills, MI (US)

(21) Appl. No.: 15/352,182

(22) Filed: Nov. 15, 2016

(51) Int. Cl. H02H 7/122; H02H 1/00; H02M 7/48

(52) U.S. Cl. CPC H02H 7/1227; H02M 7/48; H02H 1/0007

(57) ABSTRACT

A vehicle may include an inverter including a tristate buffer. The vehicle may further include a short detection circuit connected to the inverter configured to output an inhibit signal indicative of abnormal electrical behavior to the tristate buffer such that inverter output is disabled. The short detection circuit may out the inhibit signal in response to a high value comparator signal indicating deviation from a high voltage threshold or a low value comparator signal indicating deviation from a ground voltage.

### TECHNICAL FIELD

This disclosure relates to short detection and prevention for an inverter sensor input.

### BACKGROUND

Inverters may be configured to convert direct current to alternating current or vice versa. Inverters may be connected to electric machines generating or drawing alternating current. Instrumentation may be configured to provide electric machine information to the inverters as feedback or permissives. The relatively low voltage instrumentation loops may experience short circuits during operation from electric machine coolant metal content or other system conditions. The short circuits may substantially increase the voltage of the instrumentation loop.

### SUMMARY

A vehicle may include an inverter including a tristate buffer. The vehicle may further include a short detection circuit connected to the inverter and configured to output an inhibit signal indicative of abnormal electrical behavior to the tristate buffer such that inverter output is disabled. The short detection circuit may output the inhibit signal in response to a high value comparator signal indicating deviation from a high voltage threshold or a low value comparator signal indicating deviation from a ground voltage.

A vehicle may include an inverter circuit including a microcontroller. The vehicle may further include a short protection circuit connected to the inverter having a sensor input configured to cap power received at the sensor input of a microcontroller to a threshold value with a semiconductor circuit for so long as the high value comparator or the low value comparator signalling is maintained. The short protection circuit may cap power received in response to a high value comparator signalling deviation from a high voltage threshold or a low value comparator signalling deviation from a ground voltage.

An electric machine control system may include a monostable circuit configured to output a disable pulse to a microcontroller and a buffer of an inverter for a predefined duration that is greater than a duration associated with a falling edge of the signal such that inverter output is constant. The monostable circuit may output the disable pulse in response to detecting a rising edge of a signal from a comparator that detects a deviation from either an allowable upper voltage or an allowable ground voltage threshold.

### BRIEF DESCRIPTION OF THE DRAWINGS

FIG. 1 is a schematic diagram of a short detection circuit having a pair of comparators;

FIG. 2 is a schematic diagram of a short detection circuit having a pair of comparators and a monostable circuit;

FIG. 3 is a schematic diagram of a short protection circuit having a pair of semiconductors and a monostable circuit;

FIG. 4 is a timing diagram of an instrumentation loop voltage and associated component states.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A hybrid or electric vehicle may include an inverter for charging a vehicle battery or driving an electric machine. The inverter may include a microcontroller configured to receive sensor or instrument information. The microcontroller may output pulse width modulation signals to a tristate buffer connected to a gate driver. The gate driver may be further connected to power modules or IGBTs to generate or receive an alternating current associated with the electric machine. The electric machine may be cooled using an engine coolant system or another coolant loop. Sensors or instruments may be linked to the electric machine and embedded in electric machine coolant channels or be located near other areas of the electric machine.

The sensor may be connected to the microcontroller of the inverter to provide system parameters. The sensor or instrument may be any device configured to provide information to the microcontroller. For example, the sensor may be an RTD, thermocouple, thermistor, hall sensor, encoder, resolver, transducer, or another type of instrument. The electric machine stator windings may carry large currents and voltages to generate a magnetic field. Short circuits between the sensor and stator windings may cause high voltages on the sensor loop, which may damage the microcontroller or provide erroneous indication.

The inverter may have a short detection circuit configured to notify the microcontroller of the short and electrically disconnect the buffer circuit from the PWM signals of the microcontroller in response to abnormal electrical behavior. Abnormal electrical behavior may be any high or low voltage on the instrument loop or a deviation of the ground voltage. Abnormal electrical behavior may also include overcurrent situations. The short detection circuit may have a comparator configured to detect deviations from a ground voltage. The ground comparator may compare a ground voltage of the sensor loop with a ground of the electric machine. The ground comparator may compare a ground voltage of the sensor loop with an isolated ground of the vehicle. The short detection circuit may have a comparator configured to detect deviations from a high or upper threshold voltage. The high-value comparator may compare a sensor voltage with a voltage source or rail. The voltage source or rail may be nominally above the operational range of the loop. For instance, a 6-volt rail may be used to drive the sensor circuit and the high-value comparator. If the sensor loop exceeds six volts, the comparator may output a true signal.

In at least one other embodiment, a precision 2.5-volt reference may be used for both comparators. Preferably, a voltage divider circuit may be used to adjust reference voltage for comparator so that it can meet protection strategy. The 2.5-volt reference may also be a battery. A voltage divider circuit may set the 2.5-volt reference. A voltage regulator may also drive the 2.5-volt reference. For example, a Zener diode configuration or buck-boost configuration. Both of the comparators may be configured to indicate a high value in response to a fault condition. The comparators may be any type. In one embodiment, the comparators are manufactured by ROHM™ having model number BA2903HFVM-C. The comparators may be configured to compare with respect to a reference value as disclosed above, or the comparators may be configured to compare with respect to one another, indicating a fault in response to the potential between the two inputs exceeding a particular value. For example, each comparator could be configured to indicate a fault in response to the particular line voltage deviating from the threshold or crossing the threshold. In another embodiment, the comparator may be configured to indicate a fault in response to the difference in the particular voltages exceeding a threshold. The comparator output or outputs may be fed to a logical OR gate. The OR gate may combine other interrupts or permissives used to enable the tristate buffer or microcontroller output. The OR gate may be connected to the tristate buffer trigger. The tristate buffer may be a Texas Instruments™ SN54HCT125 type.

A monostable circuit may be used to reduce vacillation of the buffer circuit and the microprocessor. The monostable may be a Texas Instruments® CD74HC4538-Q1 or another implement. The monostable may be configured to output a pulse based on the rising edge of the comparator signal. The pulse may be configured to inhibit the tristate buffer output or the microcontroller output. As the inverter output is removed, high voltages in the electric machine will dissipate. As the high voltages dissipate, the comparators' detection of a short may be removed. The pulse width or duration of the pulse may be at least the expected duration required for feedback from the initial inhibit signal. For example, if testing shows that high voltages in the electric machine dissipate after five μs, the pulse width or duration may be at least six μs. The duration may be increased to prevent vacillation of the inverter output further. The comparator may have a falling edge because inhibition of the inverter will cause the removal of high voltages from the electric machine. For example, the rising edge of the comparator may cause the monostable to emit a pulse configured as a trigger to disconnect the tristate buffer. As the electric current from the inverter diminishes in the electric machine, the comparator signal may experience a falling edge. The duration of the pulse may be configured to exceed this relative feedback duration to delay reconnection of the buffer circuit after the pulse has dissipated.

In an additional or same embodiment, the monostable pulse duration is greater than a clock cycle or detection period of the microcontroller. For example, the microcontroller may have a scanning frequency of five milliseconds. In such a case, the duration of the monostable pulse may be greater than five milliseconds to ensure that software of the microcontroller detects the fault condition or change in output from the comparators. The output of monostable multi vibrator can disable buffer circuit and output of buffer circuit is fed to the microcontroller. Once microcontroller detects disabled buffer or indicating input single, the controller disables output, including the PWM signal, to the buffer circuit until it pre-output checks and permissives are met.

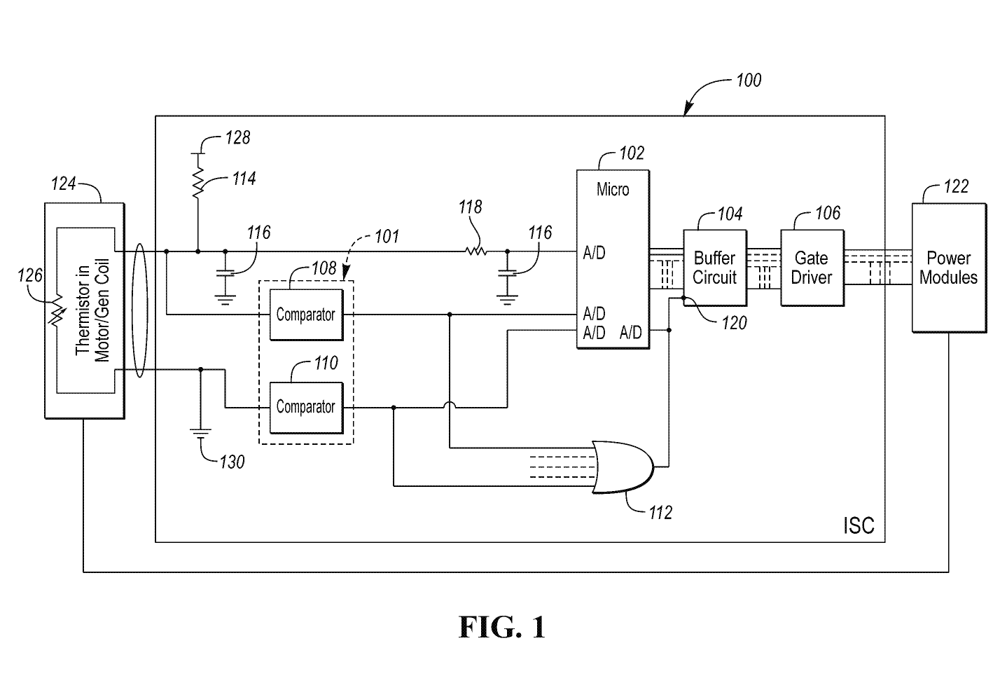

Now referring to FIG. 1, a schematic diagram of a short detection circuit 101 is shown along with an inverter system controller (ISC) or inverter circuit 100. The ISC 100 includes a microcontroller 102. The microcontroller may be any type and configured to provide a pulse width modulation (PWM) signal to the tristate buffer circuit 104. The tristate buffer 104 output may be connected to a gate driver 106 board or circuit. The gate driver 106 output may drive the gates of the power modules 122, which generate the alternating current signal used to drive the electric machine 124. Sensors or instrumentation 126 may be disposed on, within, or near the electric machine 124 to monitor system parameters. The system parameters may be related to the electric machine 124 or unrelated to the electric machine 124. For example, system parameters not directly related to the electric machine 124 may be monitored in proximity to the electric machine such that faults associated with the electric machine could cause an increase to the sensor loop voltage.

A sensor loop may have a voltage supply 128 and ground 130. The sensor loop may also include capacitors 116 and resistors 114, 118. The capacitor is used to take care of any noise on signal line. The sensor loop may be fed into an input channel of the microcontroller 102. The input channel may be an analog or digital input. The comparators may additionally be attached to an input channel of the microcontroller 102.

A pair of comparators 108, 110 may be a portion of a short detection circuit 101. One comparator may be a high-value comparator 108. The other comparator may be a low-value comparator 110. The high-value comparator may be configured to detect deviations from a threshold voltage value. A deviation may be a percentage change above the threshold value. For example, if the threshold is five volts, a deviation of more than 10% may cause the comparator to output a signal. Meaning, if the voltage of the sensor loop exceeds 5.5 volts or is less than 4.5 volts, an indicative signal will be sent to at least one of the microcontroller 102 and the OR gate 112. In another embodiment, the high-value comparator 108 may be configured to output a signal in response to the sensor loop voltage rising above a voltage threshold. For example, the sensor loop normal operating range may be between zero and five volts. The threshold may be set at six volts. The high-value comparator 108 will output a signal to the microcontroller 102 to indicate a fault or the OR gate 112 to disable buffer to switch off PWM signals to the power modules and inverter, in response to the sensor loop voltage rising above six volts.

In another embodiment, the comparator system may be defined as a window comparator topology consisting of comparator 108 and 110 being used to detect a short circuit on the sensing lines. In this configuration, the output of window comparators is low when the input voltage to window comparators is between −1.5 Volts and 6 Volts otherwise it is high. If the input from the sensing line falls within the window comparator range, the buffer is in a normal output condition, and if the input form the sensing line falls beyond the window comparator range, the buffer output is disabled. Additionally, the microcontroller may be further disable upon detection of the buffer being disable or a signal from the window comparator.

The low-value comparator 110 may be configured to detect deviations from a threshold ground voltage value. The low-value comparator 110 may compare a sensor loop ground voltage 130 to a fixed ground voltage. If the alternating voltage from the electrical machine is shorted to the sensor loop, the sensor ground voltage may have a time-varying value. Therefore, hysteresis detection of 1 Volts may be added to the low-value comparator 110. Upon detection of a time-varying signal, the comparator may be configured to indicate a fault condition. The low-value comparator 110 may measure a deviation from the predetermined amount. For example, the low-value comparator 110 may output a signal to at least one of the microcontroller 102 or the OR gate 112 in response to the ground voltage exceeding an acceptable voltage band. The acceptable voltage band may be more than a positive 1 volt or less than a negative 1 volt. In another embodiment, the low-value comparator 110 may output a signal to at least one of the microcontroller 102 or the OR gate 112 in response to the ground voltage becoming less than negative one volt. In an additional embodiment, the low-value comparator 110 may out a signal to at least one of the microcontroller 102 or the OR gate 112 in response to the ground voltage becoming more than one volt. In other embodiments, a different short or fault detection circuit 101 may be implemented. For example, the short detection circuit 101 may be one comparator comparing a difference between the sensor loop voltage and ground. If the difference exceeds a threshold, the comparator may output a signal. If either comparator 108, 110 outputs a signal, the signal may inhibit inverter 100 operation via the microcontroller 102 or tristate buffer 104.

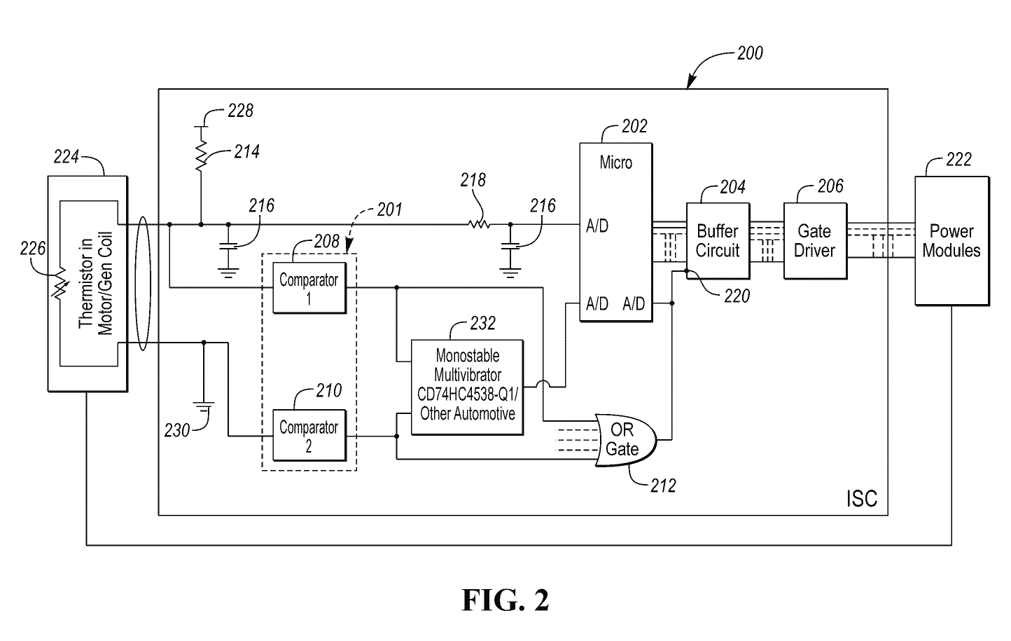

Now referring to FIG. 2, a schematic diagram of a short detection circuit is shown along with an inverter system controller (ISC) 200. The ISC 200 includes a microcontroller 202. The microcontroller may be any type and configured to provide a pulse width modulation (PWM) signal to the tristate buffer circuit 204. The tristate buffer 204 output may be connected to a gate driver 206 board or circuit. The gate driver 206 output may drive the gates of the power modules 222, which generate the alternating current signal used to drive the electric machine 224. Sensors or instrumentation 226 may be disposed on, within, or near the electric machine 224 to monitor system parameters. The system parameters may be related to the electric machine 224 or unrelated to the electric machine 224. For example, system parameters not directly related to the electric machine 224 may be monitored in proximity to the electric machine such that faults associated with the electric machine could cause an increase in the sensor loop voltage.

A sensor loop may have a voltage supply 228 and ground 230. The sensor loop may also include capacitors 216 and resistors 214, 218. The resistor 218 and capacitor 216 add a low-pass filter to of microcontroller 202 inputs. The sensor loop may be fed into an input channel of the microcontroller 202. The input channel may be an analog or digital input. The comparators may additionally be attached to an input channel of the microcontroller 202.

A pair of comparators 208, 210 may be a portion of a short detection circuit 201. One comparator may be a high-value comparator 208. The other comparator may be a low-value comparator 210. The high-value comparator may be configured to detect deviations from a threshold voltage value. A deviation may be a percentage change above the threshold value. For example, if the threshold is five volts, a deviation of more than 10% may cause the comparator to output a signal. Meaning, if the voltage of the sensor loop exceeds 5.5 volts or is less than 4.5 volts, an indicative signal will be sent to at least one of the microcontroller 202 and the OR gate 212. In another embodiment, the high-value comparator 208 may be configured to output a signal in response to the sensor loop voltage rising above a voltage threshold. For example, the sensor loop normal operating range may be between zero and five volts. The threshold may be set at six volts. The high-value comparator 208 will output a signal to at least one of the microcontroller 202 or the OR gate 212, in response to the sensor loop voltage rising above six volts.

The low-value comparator 210 may be configured to detect deviations from a threshold ground voltage value. The low-value comparator 210 may compare a sensor loop ground voltage 230 to a fixed reference voltage. The fixed reference voltage may be a ground voltage or voltage from a voltage regulator circuit or an independent voltage source. For example, the reference voltage may be from precision voltage reference. The low-value comparator 210 may measure a deviation from the predetermined amount. For example, the low-value comparator 210 may output a signal to at least one of the microcontroller 202 or the OR gate 212 in response to the ground voltage exceeding an acceptable voltage band. The acceptable voltage band may be more than a positive 0.5 volts or less than a negative 0.5 volts. In another embodiment, the low-value comparator 210 may output a signal to at least one of the microcontroller 202 or the OR gate 212 in response to the ground voltage becoming less than negative one volt. In an additional embodiment, the low-value comparator 210 may out a signal to at least one of the microcontroller 202 or the OR gate 212 in response to the ground voltage becoming more than one volt. In other embodiments, a different short or fault detection circuit 201 may be implemented. For example, the short detection circuit 201 may be one comparator comparing a difference between the sensor loop voltage and ground. If the difference exceeds a threshold, the comparator may output a signal.

One or both of the comparators 208, 210 may be fed into a monostable circuit 232 in addition to the OR gate 212 and microcontroller 202. The comparator 208, 210 output may be connected to the OR gate 212 in addition to the monostable circuit 232 to improve response time. As described above, the monostable circuit 232 may be configured to output a pulse for a predetermined duration to ensure the motor state is not vacillating.

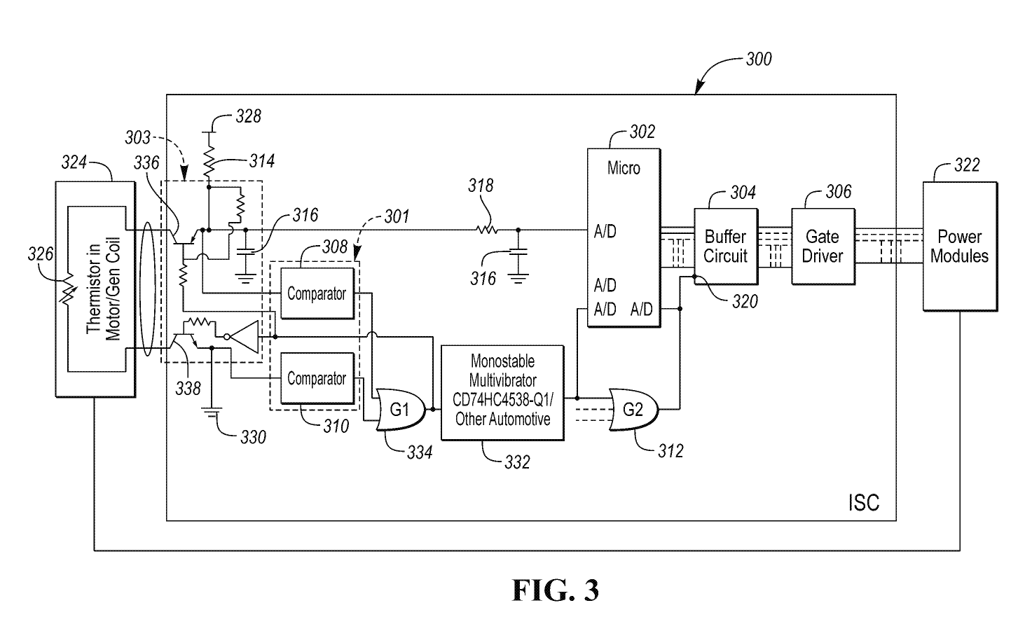

Now referring to FIG. 3, a schematic diagram of a short detection circuit is shown along with an inverter system controller (ISC) 300. The ISC 300 includes a microcontroller 302. The microcontroller may be any type and configured to provide a pulse width modulation (PWM) signal to the tristate buffer circuit 304. The tristate buffer 304 output may be connected to a gate driver 306 board or circuit. The gate driver 306 output may drive the gates of the power modules 322, which generate the alternating current signal used to drive the electric machine 324. Sensors or instrumentation 326 may be disposed on, within, or near the electric machine 324 to monitor system parameters. The system parameters may be related to the electric machine 324 or unrelated to the electric machine 324. For example, system parameters not directly related to the electric machine 324 may be monitored in proximity to the electric machine such that faults associated with the electric machine could cause an increase in the sensor loop voltage.

A sensor loop may have a voltage supply 328 and ground 330. The sensor loop may also include capacitors 316 and resistors 314, 318. Any capacitance and resistance values may be used to properly configure the guard band, accuracy, and low-pass filter requirements for each application. The sensor loop may be fed into an input channel of the microcontroller 302. The input channel may be an analog or digital input. The comparators may additionally be attached to an input channel of the microcontroller 302.

A pair of comparators 308, 310 may be a portion of a short detection circuit 301. One comparator may be a high-value comparator 308. The other comparator may be a low-value comparator 310. The high-value comparator may be configured to detect deviations from a threshold voltage value. A deviation may be a percentage change above the threshold value. For example, if the threshold is five volts, a deviation of more than 10% may cause the comparator to output a signal. Meaning, if the voltage of the sensor loop exceeds 5.5 volts or is less than 4.5 volts, an indicative signal will be sent to at least one of the microcontroller 302 and the OR gate 312. In another embodiment, the high-value comparator 308 may be configured to output a signal in response to the sensor loop voltage rising above a voltage threshold. For example, the sensor loop normal operating range may be between zero and five volts. The threshold may be set at six volts. The high-value comparator 308 will output a signal to at least one of the microcontroller 302 or the OR gate 312, in response to the sensor loop voltage rising above six volts.

The low-value comparator 310 may be configured to detect deviations from a threshold ground voltage value. The low-value comparator 310 may compare a sensor loop ground voltage 330 to a fixed reference voltage. The fixed reference voltage may be from a voltage regulator circuit or an independent voltage source. For example, the reference voltage may be a ground voltage or precision reference voltage. The low-value comparator 310 may measure a deviation from the predetermined amount. For example, the low-value comparator 310 may output a signal to at least one of the microcontroller 302 or the OR gate 312 in response to the ground voltage exceeding an acceptable voltage band. The acceptable voltage band may be more that a positive 0.5 volts or less than a negative 0.5 volts. In another embodiment, the low-value comparator 310 may output a signal to at least one of the microcontroller 302 or the OR gate 312 in response to the ground voltage becoming less than negative one volt. In an additional embodiment, the low-value comparator 310 may out a signal to at least one of the microcontroller 302 or the OR gate 312 in response to the ground voltage becoming more than one volt. In other embodiments, a different short or fault detection circuit 301 may be implemented. For example, the short detection circuit 301 may be one comparator comparing a difference between the sensor loop voltage and ground. If the difference exceeds a threshold, the comparator may output a signal.

One or both of the comparators 308, 310 may be fed into a monostable circuit 332 in addition to the OR gate 312 and microcontroller 302. The comparator 308, 310 output may be connected to the OR gate 312 in addition to the monostable circuit 332 to improve response time. As described above, the monostable circuit 332 may be configured to output a pulse for a predetermined duration to ensure the motor state is not vacillating.

Still referring to FIG. 3, the detection circuit 301 may be configured as a portion of a short protection or prevention circuit 303. The short protection circuit 303 may limit or cap or disconnect the sensor loop power, voltage and current, during short circuit events. The detection circuit 301 may be similarly configured as described above with a monostable 332. The detection circuit 301 and comparators 308, 310 may be fed to an OR gate 334 before being received by the monostable 332. The output of the OR gate 334 may be used to enable or disable switches 336, 338, which are part of the short protection circuit 303. In another embodiment, the OR gate 334 may be located after the monostable 332 circuit. The logic signal from the OR gate may have an associated high or low voltage to enable or disable the flow of current through the switches 336, 338. The switches 336, 338 may be any semiconductor or transistor (e.g., MOSFET, BJT). The switches 336, 338 may be configured to disconnect the sensor loop from the microcontroller 302. As shown, the comparators 308, 310 are located on a downstream of the respective switches 336, 338 with respect to the sensor 326. The comparators 308, 310 may also be located upstream or on the other side of the respective switches 336, 338 with respect to the sensor 326 to prevent signal bouncing or vacillating.

As shown in FIG. 3, switch 336 is a transistor having a PNP doping configuration. Switch 338 is a transistor having an NPN doping configuration. In other embodiments, different transistor configurations may be used or a pair of MOSFETs may be used. The switches may be used to disconnect circuitry from the high voltage short.

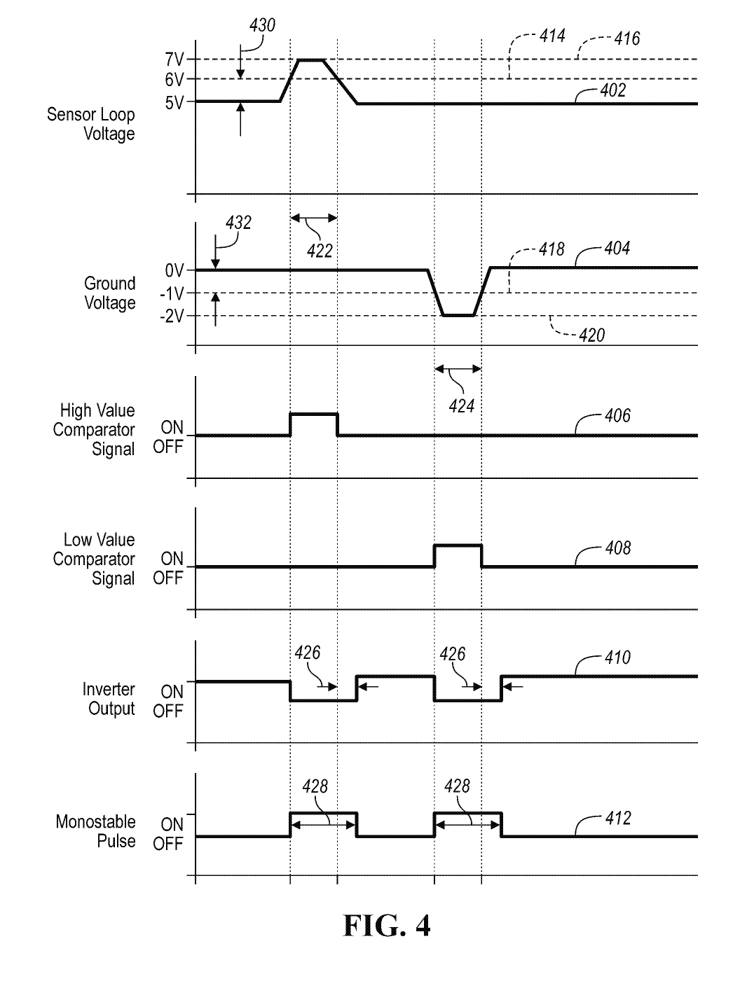

Now referring to FIG. 4, a composite timing graph 400 is shown. The graph 400 includes a sensor loop voltage 402 curve indicating the relative voltage of the sensor loop. The sensor voltage 402 is shown crossing a high voltage threshold 414. In another embodiment, the loop voltage may deviate from an acceptable voltage band. The loop voltage may be limited at a high voltage limit 416. The upper voltage threshold may be equal to the high voltage threshold 414. The protection circuit, as described above, may protect circuits of ISC against exposure to high voltages. The high voltage limit 416 may reach transient levels of over 100 volts. The size of the capacitors, as disclosed above, may reduce transient voltages during the short circuit. Subsequently, the switches 336, 338 may disconnect the sensor from the ISC. As the sensor voltage 402 crosses the high voltage threshold 414, the high-value comparator signal 406 curve or high voltage detection circuit outputs a high value. The high value may go to the monostable circuit or the microcontroller. Similarly, the graph 400 includes a ground voltage 404 curve indicating the relative voltage of the ground. As specified above, the ground voltage and sensor loop voltage may be compared with a constant voltage value. The ground voltage 404 curve is shown crossing a ground voltage threshold 418. The loop voltage may be limited by disconnecting through switch. The ground deviation limit may have an upper and lower limit. The upper and lower limits may be implemented using additional switches. The upper voltage threshold may be equal to the high voltage threshold 414. The protection circuit, as described above, may disconnect the ISC from the sensor loop or limit the sensor loop voltage, which are exposed to high voltages because of the short circuit. In another embodiment, the ground voltage 404 curve may deviate from an acceptable voltage band. As the ground voltage 404 crosses the ground voltage threshold, the low-value comparator 408 curve becomes high. The output may be fed to the monostable circuit or the microcontroller. When the comparator values are high, the monostable pulse inhibit signal 412 becomes high for a duration 428 that is longer than the tristate buffer such that inverter output 410 is disabled. The inverter output 410 may be disabled for at least as long as the monostable pulse. Software and hardware checks may delay the inverter output 410 from returning to normal after short circuit indication. The extended period creates a feedback delay 426 where the inverter output 410 is in an OFF state for longer than the comparators 406, 408 are outputting an inhibit signal. The pulse length could be any duration 428 required to ensure that software can detect faults within the protection or detection circuits to keep the inverter in shutdown mode. The length may also ensure that the inverter output does not vacillate. For example, the pulse could be five seconds or 10 ms, depending on the sensor type and fault conditions associated with the sensor. In some embodiments, the monostable pulse 412 may occur based on the rising edge of the high-value comparator signal 406 ON period 422. The monostable pulse 412 may occur based on the rising edge of the high-value comparator signal 408 ON period 424. The monostable pulse 412 may occur once the rising edge reaches minimum threshold to trigger mononstable vibrator after the high-value or low-value comparator signals 406,408 ON periods 422, 424 indicate a detection. The allowable upper voltage 303 threshold defines the maximum loop voltage before indication of a deviation is signalled. The allowable ground voltage 432 threshold defines the maximum deviation from the predetermined ground reference before indication of a deviation is signalled.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
an inverter including a tristate buffer; and
a short detection circuit connected to the inverter and configured to, in response to a high value comparator signal indicating deviation from a high voltage threshold or a low value comparator signal indicating deviation from a ground voltage, generate an inhibit signal indicative of abnormal electrical behavior for the tristate buffer such that output of the inverter is disabled.

2. The vehicle of claim 1, wherein the short detection circuit includes an OR gate having inputs configured to receive the high value comparator signal and low value comparator signal, and having an output configured to output the inhibit signal.

3. The vehicle of claim 2, wherein the inverter further includes a microcontroller configured to receive the inhibit signal and transmit indication of the abnormal electrical behavior.

4. The vehicle of claim 1, wherein the short detection circuit includes a monostable circuit configured to pulse the inhibit signal.

5. The vehicle of claim 4, wherein the pulsing has durations between 5 and 10 milliseconds.

6. The vehicle of claim 5, wherein the pulsing has durations of 10 milliseconds.

7. The vehicle of claim 4, wherein the monostable circuit is configured to receive the high value comparator signal and low value comparator signal.

8. The vehicle of claim 1, wherein the short detection circuit further includes a short protection circuit connected to the inverter and having a sensor input configured to, in response to the high value comparator signal or the low value comparator signal, limit power received at the sensor input with a semiconductor circuit.

9. A vehicle comprising:
an inverter circuit including a microcontroller; and
a short protection circuit connected to the inverter circuit and having a sensor input configured to, in response to a high value comparator signalling deviation from a high voltage threshold or a low value comparator signalling deviation from a ground voltage, cap power received at the sensor input to a threshold with a semiconductor circuit for so long as either of the signalling is maintained.

10. The vehicle of claim 9, wherein the semiconductor circuit includes a pair of transistors.

11. The vehicle of claim 10, wherein the pair is arranged in a push-pull structure.

12. The vehicle of claim 11, wherein the pair receives input from a fault detection circuit connected to the inverter and configured to, in response to the high value comparator or the low value comparator , output a signal indicative of abnormal electrical behavior.

13. The vehicle of claim 12, wherein the fault detection circuit includes an OR gate having inputs configured to receive the high value comparator and low value comparator, and an output configured to output the signal.

14. The vehicle of claim 13, wherein the inverter further includes a microcontroller configured to receive the signal and transmit indication of the abnormal electrical behavior.

15. The vehicle of claim 14, wherein the fault detection circuit includes a monostable circuit configured to receive the high value comparator and low value comparator, and to pulse the signal.

16. An electric machine system comprising:
a monostable circuit configured to, in response to detecting a rising edge of a signal from a comparator that indicates deviation from an allowable upper voltage or an allowable ground voltage, output a disable pulse to a microcontroller and a buffer of an inverter for a predefined duration that is greater than a duration associated with a falling edge of the signal such that output of the inverter is constant.

17. The electric machine system of claim 16, wherein the pulse is between 5 and 10 milliseconds.

18. The electric machine system of claim 17, wherein the pulse is 10 milliseconds.

19. The electric machine system of claim 16 further comprising a fault detection circuit connected to the inverter and configured to, in response to a high value of the signal indicating deviation from a high voltage threshold or a low value of the signal indicating deviation from a ground voltage, output a signal indicative of abnormal electrical behavior.

20. The electric machine system of claim 16 further comprising, a short protection circuit connected to the inverter and having a sensor input configured to, in response to a high value of the signal or a low value of the signal, limit the power received at the sensor input with a semiconductor circuit.
